(19) United States
(12) Patent Application Publication
(10) Pub. No.: US 2002/0191232 A1
(43) Pub. Date: Dec. 19, 2002

(54) Overhead slide projector with output capabilities

(76) Inventor: Genaro Antonio Fernandez Orozco, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/884,611

(22) Filed: Jun. 18, 2001

(51) Int. Cl. H04N 1/46

(52) U.S. Cl. 358/506

(57) ABSTRACT

An overhead slide projector having copier capability in a single, multifunctional unit. A scanning unit is incorporated into the housing of an overhead projector. Digital transmission output ports are provided for transmitting signals indicative of the slide content digitized by the scanning unit. An associated hard copy unit can also be incorporated into the housing. Electronic or hard copy outputs of a transparency currently on the projector stage can be immediately generated.

### FIELD OF THE INVENTION

The present invention relates generally to office equipment, more particularly to overhead slide projectors such as used for business meetings and, specifically, to an overhead slide projector incorporating at least one output capability.

### BACKGROUND OF THE INVENTION

As shown in FIG. 1 (Prior Art), an overhead slide projector 10 of the under-mirror type is known in the state of the art. Such machines are generally used for business meetings to project previously prepared information slides having computer-generated content thereon or to generate dry marker slides from transparency media in real time (as opposed to using a blackboard or whiteboard to facilitate the meeting). The projector 10 includes a housing 13 having a top surface which includes a stage 12 on which a slide, or transparency, 11 bearing an image (or blank for writing on) to be projected onto a projection screen or wall is placed. The housing 13 generally encloses a light source for illuminating the transparency 11 from below the stage 12, a converging Fresnel lens, and a cooling fan (none of which are shown). A mast 14, standing upwardly from one of the corners of the housing 13, supports a projection head assembly 20 such that the assembly 20 is located over the stage 12. The projection head assembly 20 includes a reflecting mirror 21 for reflecting the image on the slide 11 currently upon stage 12 and a projecting lens 22 associated with the mirror for beaming the image to a projection screen. A focusing device 23 is provided for the projection head assembly 20. An ON-OFF switch 31 activates the lamp, cooling fan, and any other electrical subassemblies.

Whether the slide is previously prepared such as with a computer presentation application software and color printer, or is drawn in real time on a blank transparency, an often heard comment at a meeting in which the projection is presented is, “Can I have a copy of that slide?” Generally, the presenter must make note of the person and the particular slide of interest and generate another copy at a later time, either using a copy machine or the computer-printer system. This is inefficient.

Therefore, there is a need for an improved overhead transparency projector having at least one, immediate output capability.

### SUMMARY OF THE INVENTION

In its basic aspects, the present invention provides an overhead projector system including: a projector assembly including a transparency stage; adjacent said stage, a scanner assembly for digitizing content of a current transparency on said stage; and an output device for extracting said content from said system.

In another aspect, the present invention provides a multifunction office equipment apparatus including: an overhead slide projector, having a housing including a transparency stage; within said housing, subjacent said stage, a scanner for digitizing content from a current slide 11 on said stage; and within said housing, connected to said scanner, output means for transmitting a copy of said content.

In another aspect, the present invention provides a method of producing a copy of a slide from an overhead projector, the method including: placing a slide of interest on a projection stage of the projector; scanning said stage having the slide of interest thereon for digitizing content thereof; generating an output signal representative of the content.

The foregoing summary is not intended to be an inclusive list of all the aspects, objects, advantages, and features of the present invention nor should any limitation on the scope of the invention be implied therefrom. This Summary is provided in accordance with the mandate of 37 C.F.R. 1.73 and M.P.E.P. 608.01 (d) merely to apprise the public, and more especially those interested in the particular art to which the invention relates, of the nature of the invention in order to be of assistance in aiding ready understanding of the patent in future searches.

Objects, features and advantages of the present invention will become apparent upon consideration of the following explanation and the accompanying drawings, in which like reference designations represent like features throughout the drawings. The drawings referred to in this specification should be understood as not being drawn to scale except if specifically annotated.

### DESCRIPTION OF THE DRAWINGS

FIG. 1 (Prior art) exemplifies an overhead slide projector.

FIG. 2 is an overhead slide projector and hard copy apparatus in accordance with the present invention.

FIG. 2A is a block diagram of the present invention as shown in FIG. 2.

### DETAILED DESCRIPTION OF THE INVENTION

Reference is made now in detail to a specific embodiment of the present invention, which illustrates the best mode presently contemplated by the inventor for practicing the invention. Alternative embodiments are also briefly described as applicable.

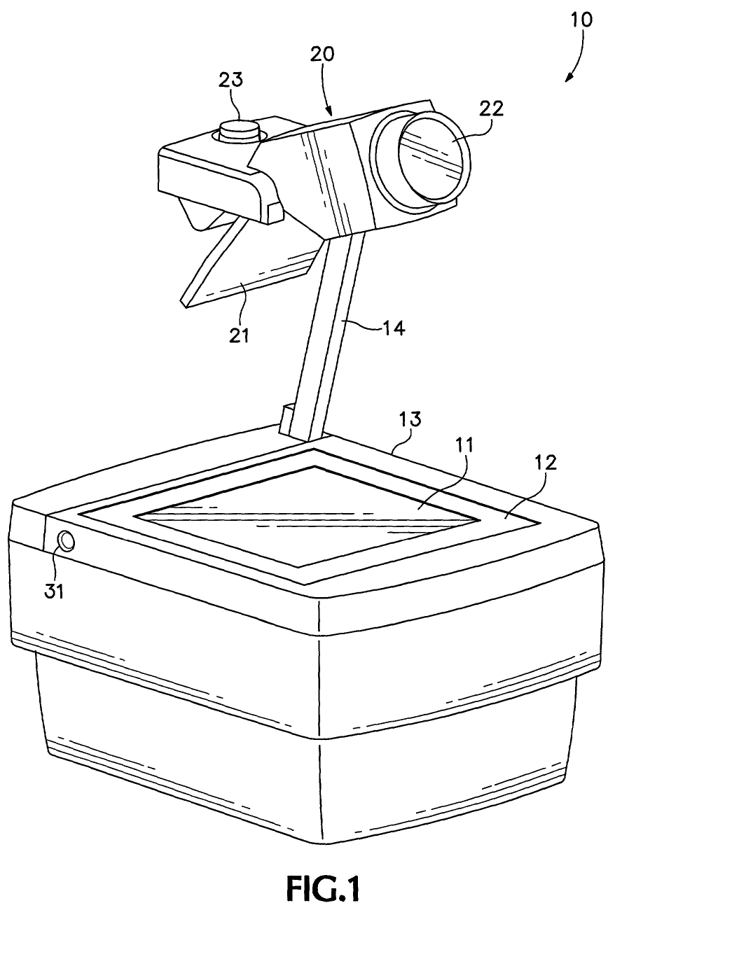

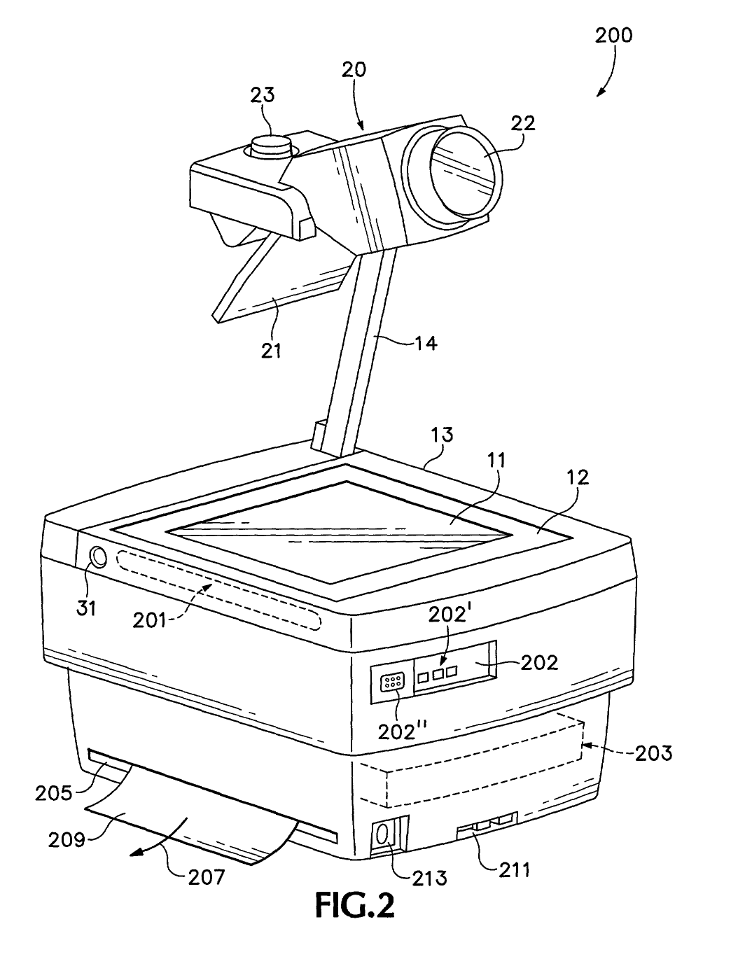

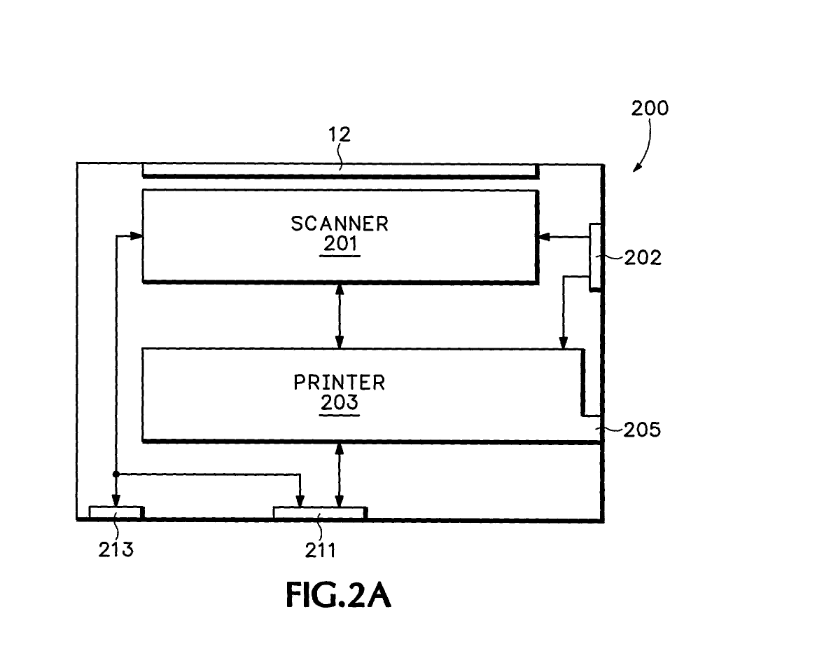

FIG. 2 illustrates an overhead projector apparatus 200 with output capability in accordance with the present invention. An associated block diagram of the apparatus 200 is presented in FIG. 2A. The projector subunit is substantially the same as typified by FIG. 1 (Prior Art) or the like as would be known in the state of the art.

Internally to the housing 13, a scanner subunit 201 is appropriately mounted in proximity to the stage 12 (see phantom line demonstration in FIG. 2). Such document reading and digitizing scanner apparatus are well known in the art (see U.S. Patent references hereinafter). Thus, a scanner such as an HP™ ScanJet™ assembly, or its components, can be adapted to a specific implementation for mounting within the housing 13.

A housing-mounted control panel 202, having appropriate button(s) 202′ for activating the scanner 201 and reading the current slide 11 on the stage 12 is provided; for example, the industry standard green button for copying, including making multiple copies. Generally, scanning will require turning off the projector lamp and providing a simple backing, such as a white sheet of paper 11 (some transparencies have such a backing already attached with a flexible perforation hinge) for the transparency to be scanned. A switch for turning off the lamp without turning off the entire projector (viz., leaving the cooling fan running) may be included as part of the control panel 202. Operational software or firmware can include advanced features, such as voice recognition and the like, to generate requested output.

Also internally to the housing 13, a printing unit 203 is mounted and appropriately electrically linked (see representative arrows FIG. 2A) to the scanner 201. For example, an ink-jet printing apparatus such as an HP™ DeskJet™ printing apparatus or its components can be adapted to a specific implementation within the housing 13. A hard copy output port 205 for the printing unit 203 of the apparatus 200 is provided for ejecting (arrow 207) a hard copy 209 of the scanned slide 11 from the housing. The printer is also provided with appropriate control buttons 202″ on control panel 202. It is intended by the inventor that, alternatively, laser, thermal, or other hard copy output unit implementations can be employed in accordance with the present invention.

One combination ink-jet printer and scanner is taught in U.S. Pat. No. 5,070,410, filed on Mar. 21, 1989 by Hadley for an APPARATUS AND METHOD USING A COMBINED READ/WRITE HEAD FOR PROCESSING AND STORING READ SIGNALS AND FOR PROVIDING FIRING SIGNALS TO THERMALLY ACTUATED INK EJECTION ELEMENTS; another is taught in U.S. Pat. No. 5,532,825, filed Aug. 30, 1993 by Lim et al. for an ADD-ON SCANNER FOR EXISTING INK JET PRINTER (each assigned to the common assignee herein and incorporated herein by reference).

With the incorporation of the scanner 200 subunit, the apparatus 200 can be provided with a computer cable interface data port 211, and even with an infrared link data port 213, so that with the appropriate software application, the apparatus can be used to output digital signals representative of the slide 11 content. This type of output capability can be in substitution for (in a lower cost apparatus 200) or in addition to the hard copy subunit 203. Hard copy output capabilities can include standard functions such as collating, stapling or other binding, or other like finishing processes.

Furthermore, depending on the specific implementation, these ports 211, 213 can be used by persons attending the meeting with portable equipment, e.g., a notebook computer having an infrared port and scanning software, to immediately obtain and electronic version of the slide of interest. Wired or wireless network interconnections can be used. Similarly, known manner facsimile-modem output or other digital data sender subsystem can be implemented using one of the ports 211, 213 for remote transmission of the slide of interest. Thus, video conference attendees can also obtain a copy in digital data form. In specific implementations, other known manner data porting functions can be provided for notebook computers, palmtop computers, personal digital assistants (PDA), Internet-ready devices, or the like digital devices commonly found at a business meeting or conference where the projector is being used.

Moreover, the apparatus 200 can be made multi-functional using the data ports 211, 213, acting as a scanner and printer computer peripheral when connected to a computing device.

In a simplified embodiment, the copier unit is an external hard copy apparatus, such as said HP DeskJet ink-jet printer coupled to the internal scanner 201 via one of the ports 211, 213.

Thus, the present invention provides an overhead slide projector having copier capability in a single, multifunctional unit 200. A scanning unit 201 is incorporated into the housing 13 of an overhead projector. Digital transmission output ports 211, 213 are provided for transmitting signals indicative of the slide content digitized by the scanning unit. An associated hard copy unit 203 can also be incorporated into the housing. Electronic or hard copy outputs of a transparency 11 currently on the projector stage 12 can be immediately generated.

The foregoing description of the preferred embodiment of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . ”

What is claimed is:

1. An overhead projector system comprising:
a projector assembly including a transparency stage;
adjacent said stage, a scanner assembly for digitizing content of a current transparency on said stage; and
an output device for extracting said content from said system.

2. The system as set forth in claim 1 further comprising:
associated with said scanner, a hard copy apparatus internal to said projector assembly for providing a hard copy output of said current transparency.

3. The system as set forth in claim 1 wherein the output device comprises:
at least one digital data sending device.

4. A multifunction office equipment apparatus comprising:
an overhead slide projector, having a housing 13 including a transparency stage;
within said housing, subjacent said stage, a scanner for digitizing content from a current slide on said stage; and
within said housing, connected to said scanner, output means for transmitting a copy of said content.

5. The apparatus as set forth in claim 4 wherein the output means comprises:
an electrical signal output port.

6. The apparatus as set forth in claim 4 wherein the output means comprises:
an infrared signal output port.

7. The apparatus as set forth in claim 4 wherein the output means comprises:
within said housing, a hard copy output device.

8. The apparatus as set forth in claim 4 wherein the output means comprises:
a digital data sending subsystem.

9. A method of producing a copy of a slide from an overhead projector, the method comprising:
placing a slide of interest on a projection stage of the projector;
scanning said stage having the slide of interest thereon for digitizing content thereof;
generating an output signal representative of the content.

10. The method as set forth in claim 9 wherein generating an output comprises:
printing a hard copy of said content, and
outputting said hard copy from said projector.

11. The method as set forth in claim 9 wherein generating an output comprises:
porting a signal representative of the content.
